(19) United States
(12) Patent Application Publication
(10) Pub. No.: US 2026/0109115 A1
(43) Pub. Date: Apr. 23, 2026

(54) MANUFACTURING AN ACOUSTIC PANEL BY LASER WELDING

(71) Applicant: SAFRAN, PARIS (FR)

(72) Inventor: Nicolas Pierre LANFANT, MOISSY-CRAMAYEL (FR)

(21) Appl. No.: 19/487,797

(22) PCT Filed: May 20, 2024
(86) PCT No.: PCT/FR2024/050649

§ 371 Date: Nov. 25, 2025

(30) Foreign Application Priority Data
May 26, 2023 (FR) FR2305269

(51) Int. Cl. B29C 65/16; B29C 65/00; B29K 79/00; B29K 81/00

(52) U.S. Cl. CPC B29C 65/1638; B29C 66/72141; B29K 2079/085; B29K 2081/06; B29K 2995/0002

(57) ABSTRACT

A method for manufacturing an acoustic panel includes the assembly of at least one acoustic component with an acoustic skin, the acoustic component including a plurality of hollow acoustic elements having a shape progressively tapering between a base and an apex, the bases of the hollow acoustic elements being connected to one another by connecting edges, wherein the connecting edges of the acoustic component are made of a transparent thermoplastic material and wherein the acoustic skin is made of an opaque thermoplastic material, and the connecting edges are attached to the acoustic skin by laser welding.

### TECHNICAL FIELD

The present invention relates to the general field of acoustic attenuation structures. More particularly, it relates to acoustic attenuation structures used to reduce the noise produced by airplane engines such as gas turbines or exhausts thereof.

### PRIOR ART

Acoustic attenuation panels typically consist of an acoustic surface plate or skin that is permeable to the acoustic waves that it is desired to attenuate, and a reflective solid plate or skin, referred to as a “closure plate”, a multicellular body being disposed between these two skins. The multicellular body generally consists of a set of partitions, for example in the shape of a honeycomb, delimiting a plurality of cells. In a well-known manner, such panels form Helmholtz resonators which can attenuate acoustic waves in a certain frequency range. Acoustic attenuation panels of this type are described, in particular, in documents U.S. Pat. No. 5,912,442 and GB 2 314 526.

These acoustic attenuation panels are limited to simple cell shapes such as those of alveoli disposed in a NIDA® type honeycomb. Consequently, when it is desired to treat low frequencies, it is necessary to use thick multicellular bodies.

One solution for treating low frequencies without using an excessively thick multicellular body is to place hollow acoustic elements, for example open truncated cones, in the cells of the multicellular body as described in FR 3 082 987.

In order to manufacture such an acoustic panel, it is therefore necessary to assemble the acoustic skin with the hollow acoustic elements, the hollow acoustic elements with the multicellular body, and the multicellular body with the optional closure skin.

Adhesive can be used to assemble the hollow acoustic elements with the acoustic skin. However, the risk of the adhesive falling inside said hollow acoustic elements is rather high. However, the presence of adhesive inside hollow acoustic elements would lead to an alteration in acoustic performance.

The assembly of the hollow acoustic elements with the acoustic skin can be carried out by conductive welding. However, the risk of deforming the hollow acoustic elements under the effect of the heat generated by the conduction for carrying out the welding is significant, whereas such deformation would lead to a deterioration in acoustic performance. The less fine and thinner the hollow acoustic elements, the greater the risk of deformation under the effect of heat.

### DISCLOSURE OF THE INVENTION

The aim of the present invention is to overcome the above-mentioned disadvantages by providing a solution for assembling the hollow acoustic elements with the acoustic skin, without the risk of reducing the acoustic performance of the resulting acoustic panel.

For this purpose, the invention proposes a method for manufacturing an acoustic panel comprising the assembly of at least one acoustic component with an acoustic skin, said acoustic component comprising a plurality of hollow acoustic elements having a shape progressively tapering between a base and an apex, the bases of the hollow acoustic elements being connected to one another by connecting edges, the assembly comprising:
positioning the acoustic skin in contact with the connecting edges of said acoustic component,
holding the acoustic skin in position against the connecting edges, and
attaching the connecting edges of the acoustic component to the acoustic skin, while continuing to hold it in position,
the method being characterised in that the connecting edges of the acoustic component are made of a thermoplastic material that is transparent for at least one determined laser wavelength, and in that the acoustic skin is made of a thermoplastic material that is opaque for at least the determined laser wavelength, and in that attachment of the connecting edges to the acoustic skin comprises emitting a laser beam having the determined wavelength and passing through the connecting edges until it reaches the contact interface between the connecting edges and the acoustic skin such as to cause localised heating at said contact interface resulting in welding of the connecting edges to the acoustic skin.

Thus, by choosing an opaque material for the acoustic skin and a transparent material for the hollow acoustic elements, laser welding of the hollow acoustic elements to the acoustic skin can be carried out. This welding method has the advantage of being highly localised, thus greatly reducing the risk of deformation of hollow acoustic elements.

In addition, compared with solutions using adhesive to attach the connecting edges of the acoustic component to the acoustic skin, adhesive does not fall into the hollow acoustic elements and thus reduce the acoustic performance of the acoustic panel.

The term “material transparent for at least one determined laser wavelength” is used herein to refer to a material that allows at least said specific wavelength to pass through the material in the form of a laser. The term “opaque for at least the determined laser wavelength” is used herein to refer to a material that prevents said given wavelength from passing through the material in the form of a laser.

For example, the transparent material may allow the passage of at least wavelengths between 800 nm and 3000 nm, for example between 1500 nm and 2000 nm. For example, the opaque material may prevent the passage of wavelengths between 800 nm and 3000 nm, for example between 1500 nm and 2000 nm.

In the remainder of the description, for reasons of simplification, the term “transparent” will mean “transparent for at least one determined laser wavelength” and the term “opaque” will mean “opaque for at least the determined laser wavelength”.

The welding used could be, for example, longitudinal seam welding (LSW).

According to a particular embodiment of the invention, the acoustic skin is held in position against the connecting edges of the acoustic component during the attachment by means of a sheet made of transparent material placed under vacuum, the sheet being configured to apply pressure to the apexes of the hollow acoustic elements of the acoustic component, so that the connecting edges of the acoustic component are held against the acoustic skin, the laser beam passing through said sheet before passing through the connecting edges during the attachment.

Thus, this improves the holding of the acoustic component in position against the acoustic skin, in particular when the acoustic component is large or has a complex three-dimensional shape. This method also enables the acoustic component to be pressed against the acoustic skin, which facilitates the laser welding. In addition, the repeatability of the position holding is improved.

According to another particular embodiment of the invention, a grid is interposed between the sheet and the acoustic component, said grid being in contact with the apexes of the hollow acoustic elements.

Such a grid reduces the risk of damage to the sheet by the apexes of the hollow acoustic elements, while ensuring more even pressure of the sheet on the acoustic component. In addition, the repeatability of the position holding is improved.

According to another particular embodiment of the invention, the connecting edges of the acoustic component are made of polyetherimide or polyethersulfone resin.

Such a resin is suitable for the manufacture of very fine hollow acoustic elements, while at the same time being able to provide excellent transparency.

According to another particular embodiment of the invention, a plasma treatment is applied to the acoustic skin and/or the connecting edges of the acoustic component before attachment.

This treatment facilitates and improves the welding of the acoustic component to the acoustic skin.

According to another particular embodiment of the invention, the acoustic skin has a plurality of perforations before being assembled with the acoustic component.

By making the perforations before assembly, there is no risk of damaging the hollow acoustic elements when the perforations are made. In addition, these perforations can be used to facilitate the holding of the acoustic component in position against the acoustic skin, for example by enabling air to be sucked out of said elements in order to generate the vacuum.

According to another particular embodiment of the invention, the acoustic skin is made of a composite material comprising long fibres.

Thus, the opacity of the acoustic skin is very high, making welding easier and quicker.

According to another particular embodiment of the invention, the method further comprises assembling at least one multicellular body with one or more acoustic components, the assembly between the multicellular body or bodies and the acoustic component or components being carried out such that the hollow acoustic elements are disposed in the cells of the multicellular body or bodies.

### BRIEF DESCRIPTION OF THE DRAWINGS

FIG. 1 is a schematic exploded perspective view of an acoustic panel obtained by the method of the invention.

FIG. 2 is a schematic cross-sectional view of the acoustic panel of FIG. 1.

FIG. 3 is a schematic cross-sectional illustrating the positioning of the acoustic component against the acoustic skin.

FIG. 4 is a schematic cross-sectional view illustrating the holding of the acoustic component in position against the acoustic skin.

FIG. 5 is a schematic cross-sectional view illustrating the welding of the acoustic component to the acoustic skin.

### DESCRIPTION OF THE EMBODIMENTS

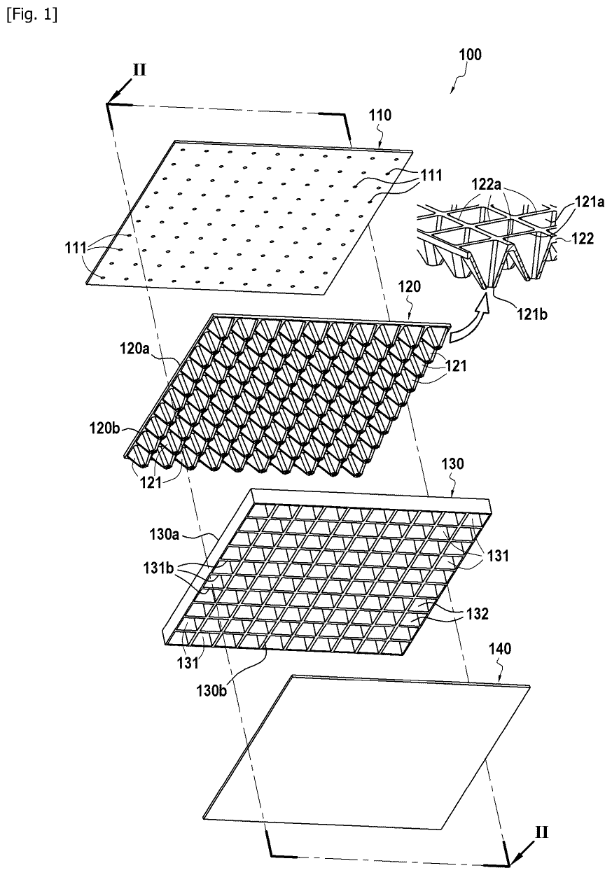

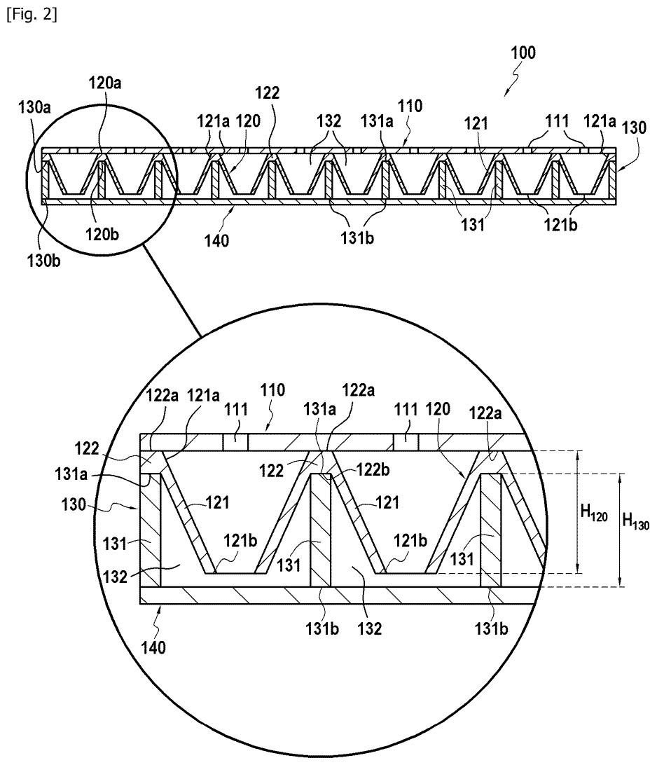

FIGS. 1 and 2 illustrate an example of an acoustic panel 100 comprising, in order, an acoustic skin 110, an acoustic component 120 comprising a plurality of hollow acoustic elements 121, a multicellular body 130 and a closure skin 140.

The function of the acoustic skin 110 is to allow the sound waves that are to be attenuated to pass into the interior of the acoustic panel 100. For this purpose, the acoustic skin 110 comprises a plurality of perforations 111, as illustrated in FIGS. 1 and 2. Each perforation 111 in the acoustic skin 110 preferably corresponds to a cell in the multicellular body 130 and to a hollow acoustic element 121 in the acoustic component 120. The acoustic skin 110 can be between 1 mm and 5 mm thick, for example 1.5 mm.

The acoustic skin 110 can be produced in a well-known manner by stamping, by automatic placing of fibres, known as “AFP” (Automated Fibre Placement), or by automatic draping of tape, known as “ATL” (Automated Tape Lying). Other methods can also be used to manufacture the acoustic skin 110, such as manual draping.

In accordance with the invention, the acoustic skin 110 is made of an opaque thermoplastic material. The opaque thermoplastic material may be a composite material comprising a thermoplastic matrix and fibres or particles. The thermoplastic matrix used may be opaque per se. The thermoplastic matrix may also be transparent, the opacity being achieved by the fibres or particles. Preferably, the opaque thermoplastic material is a composite material comprising a thermoplastic matrix and long fibres. The long fibres may be continuous or discontinuous. The long discontinuous fibres have a length of between 8 and 100 mm. The long continuous fibres have a length greater than 100 mm. Thus “long fibres” refers to fibres with a length greater than or equal to 8 mm. The fibres may be made of carbon, glass or aramid. The thermoplastic matrix can be made, for example, from polyaryletherketone (PAEK), polyetherketoneketone (PEKK), polyetherimide (PEI), polyphenylene sulfide (PPS), polyethersulfone (PESU) or polycarbonate (PC).

The closure skin 140 is a solid surface designed to reflect sound waves entering the acoustic panel 100. The closure skin 140 may be a component of the acoustic panel, as in the example described here, or may correspond to a structure of an object, for example an aircraft engine. In the latter case, the acoustic panel has no closure skin and is mounted directly on the structure of the object.

The closure skin 140 can be produced in a well-known manner by stamping, by automatic placing of fibres, known as “AFP” (Automated Fibre Placement), or by automatic draping of tape, known as “ATL” (Automated Tape Lying). Other methods can also be used to manufacture the closure skin 140. For example, the closure skin can be pre-cured and then assembled by bonding on the multicellular body, or it can be formed and cured directly on the multicellular body.

The closure skin 140 can be made of a composite material comprising fibres, for example a composite material based on carbon fibres impregnated with a thermoplastic or thermosetting resin. The closure skin 140 need not comprise any fibres. The closure skin 140 may comprise all the fibre types and all the matrix types described above for the acoustic skin 110. The closure skin 140 may also comprise other types of fibre and other types of matrix than those described above.

The multicellular body 130 comprises a plurality of partitions 131 which form an array of ribs, thus delimiting cells 132. The partitions 131 each extend between a top edge 131a and a bottom edge 131b. The upper edges 131a of the partitions 131 define a first assembly face 130a of the multicellular body 130. The lower edges 131b of the partitions 131 define a second assembly face 130b of the multicellular body 130. The cells 132 thus extend from the first assembly face 130a to the second assembly face 130b of the multicellular body 130.

The heights H₁₃₀ of the cells 132 of the multicellular body 130 are chosen so as to obtain a treatment of the frequencies of interest, according to the use that will be made of the acoustic panel 100.

In the example shown in FIGS. 1 and 2, the cells 132 of the multicellular body 130 have a square cross-section. Of course, it does not depart from the scope of the invention if the cells 132 of the multicellular body 130 have a hexagonal, rectangular, round or other cross-section.

The multicellular body 130 can be made from a polymer, composite or metal material, by additive manufacturing or by conventional means. The multicellular body 130 can also be made in a well-known manner from thermoplastic material, by injection moulding, folding or tube assembly. The thermoplastic material can be filled with short fibres or long fibres. The multicellular body 130 need not be filled.

The acoustic component 120 comprises a plurality of hollow acoustic elements 121 each having a shape progressively tapering between a base 121a and an apex 121b. The hollow acoustic elements 121 are connected to one another by one or more connecting edges 122. The connecting edges 122 comprise an upper face 122a, located in the same plane as the bases 121a of the hollow acoustic elements 121, and a lower face 122b opposite the upper face 122a. The bases 121a of the hollow acoustic elements 121 and the upper faces 122a of the edges 122 define a first assembly face 120a of the acoustic component 120. The first assembly face 120a of the acoustic component 120 is intended to be assembled in contact with the acoustic skin 110. The lower faces 122b of the edges 122 define a second assembly face 120b of the acoustic component 120. The second assembly face 120b of the acoustic component 120 is intended to be assembled in contact with the multicellular body 130. More specifically, the second assembly face 120b of the acoustic component 120 is intended to be assembled in contact with the first assembly face 130a of the multicellular body 130.

In the example shown in FIGS. 1 and 2, the hollow acoustic elements 121 are pyramid-shaped. However, it does not depart from the scope of the invention if the hollow acoustic elements have a conical, spiral or funnel shape, for example. In the example shown in FIGS. 1 and 2, the hollow acoustic elements 121 are symmetrical. However, it does not depart from the scope of the invention if the hollow acoustic elements are asymmetrical.

The hollow acoustic elements 121 can have a wall thickness of between 0.25 mm and 2 mm. Preferably, the hollow acoustic elements 121 have a thickness less than 1 mm, for example between 0.3 mm and 0.5 mm. Preferably, the base 121a of the hollow acoustic elements 121 is included in a circle having a diameter of between 5 mm and 50 mm. For example, the base 121a of the hollow acoustic elements 121 is included in a circle having a diameter of 20 mm.

Preferably, the height H₁₂₀ of the hollow acoustic elements 121 is between 5 mm and 100 mm. For example, the height H₁₂₀ of the hollow acoustic elements 121 is 20 mm. The height H₁₂₀ of the hollow acoustic elements 121 is less than the height H₁₃₀ of the cells 132 of the multicellular body 130.

The acoustic component 120 can be produced in a well-known manner by additive manufacturing, injection moulding or stamping.

The acoustic component 120 can also be produced in a well-known manner by injection-compression of a thermoplastic material. Injection-compression involves injecting the material into a partially-open mould. Thus, even if the material freezes, the channels are less obstructed. When the material is distributed throughout the mould, it is completely closed by a closing force in order to return to the correct dimension. This enables thinner wall thicknesses to be achieved for the acoustic components than with a conventional injection moulding process.

The acoustic component 120 may also be produced in a well-known manner by injection moulding of a thermoplastic material with temperature control of the tool. Injection moulding with tool temperature control involves controlling the temperature of the tool or mould by means of a tool temperature control system, for example with a heat transfer fluid or with air.

In accordance with the invention, the connecting edges 122 are made of a transparent thermoplastic material. The entire acoustic component 120 may be made of transparent thermoplastic material. Only a part of the acoustic component 120 need be made of transparent thermoplastic material, said part comprising the connecting edges 122. The hollow acoustic elements 121 may be made of transparent thermoplastic material. Thus, at least the connecting edges 122 of the acoustic component 120 can be made from a transparent resin which can be used to manufacture said connecting edges 122 and which enables said connecting edges 122 to be welded to the acoustic skin 110. Thus, preferably, the transparent thermoplastic material may be a polyetherimide (PEI). The transparent thermoplastic material may also be a polycarbonate (PC). Preferably, the transparent thermoplastic material is unfilled, i.e. it does not comprise fibres or particles. Preferably, the transparent thermoplastic material is amorphous, i.e. without a crystalline phase.

In the example shown in FIGS. 1 and 2, the acoustic panel 100 comprises only a single multicellular body and a single acoustic component. Of course, it does not depart from the scope of the invention if the acoustic panel comprises a plurality of superimposed multicellular bodies. It also does not depart from the scope of the invention if the acoustic panel comprises a plurality of acoustic components. The acoustic panel may also comprise intermediate acoustic skins delimiting different levels of the acoustic panel.

Assembly of the acoustic component 120 with the acoustic skin 110 comprises a positioning step, a position-holding step and a welding step.

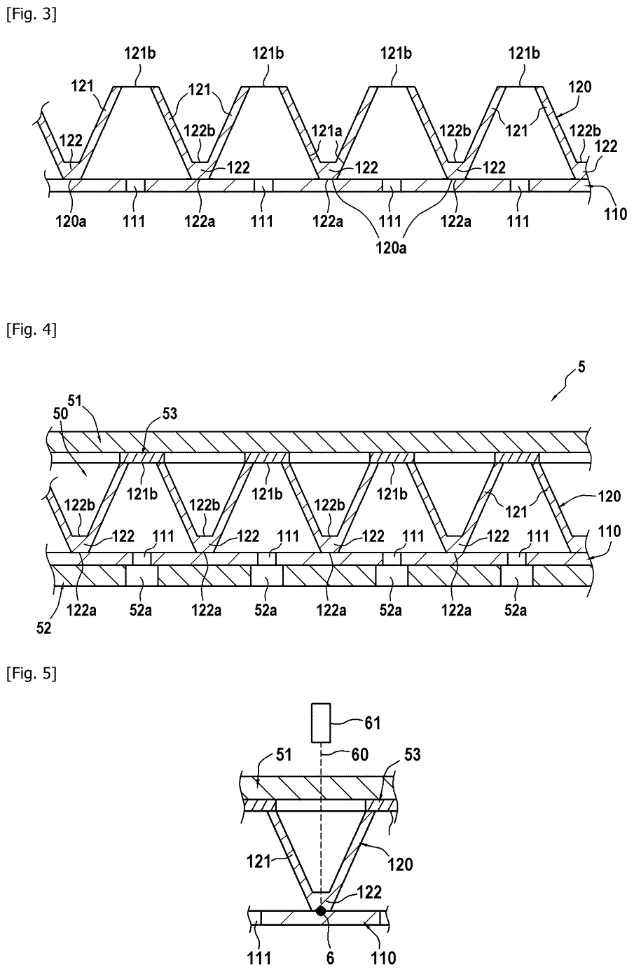

During the positioning step, the acoustic component 120 is placed in contact with the acoustic skin 110, as illustrated in FIG. 3. More precisely, the first assembly face 120a of the acoustic component 120 is disposed in contact with the acoustic skin 110, i.e. the upper faces 122a of the edges 122 are disposed in contact with the acoustic skin 110.

Preferably, the acoustic skin 110 already has the perforations 111 before being assembled with the acoustic component 120. In this configuration, the acoustic component 120 is disposed in contact with the acoustic skin 110 such that the perforations 111 open out inside the hollow acoustic elements 121 and not on the connecting edges 122. By making the perforations 111 in the acoustic skin 110 before assembly, the risk of the hollow acoustic elements 121 being damaged by a perforation step after assembly is avoided.

The acoustic component 120 is then held in position in contact with the acoustic skin 110, i.e. the upper faces 122a of the edges 122 are held in position in contact with the acoustic skin 110. This position holding will continue during the welding step, in order to ensure satisfactory welding. Preferably, position holding is achieved by applying a pressure such that the upper faces 122a of the edges 122 are pressed against the acoustic skin 110. Thus welding is facilitated.

When the acoustic panel to be manufactured has small dimensions, for example less than 500 mm long and 500 mm wide, it can be held in position by conventional means, such as a press system or a clamp, for example. The position holding can then be achieved mainly at the edges of the acoustic skin 110 and the acoustic component 120.

When the acoustic panel to be manufactured has large dimensions, for example a length and/or width greater than 500 mm, or a complex three-dimensional shape, holding in position by conventional means may not be sufficient. In this case, according to a particular embodiment of the invention, rollers configured to apply pressure upstream or downstream of the passage of the laser may be used. Also in this case, according to another particular embodiment of the invention, the position holding is achieved by means of a transparent sheet placed under vacuum, as shown in FIG. 4.

In this particular embodiment of the invention, a vacuum installation 5 is used, as shown in FIG. 4. The acoustic component 120 and the acoustic skin 110 are disposed in a vacuum chamber 50. The vacuum chamber 50 is delimited by at least one vacuum sheet 51. The vacuum sheet 51 is disposed opposite the apexes 121b of the hollow acoustic elements 121 of the acoustic component 120. In this way, the vacuum sheet 51 is opposite the bases 121a of the hollow acoustic elements 121 and the acoustic skin 110.

Thus, when the chamber 50 is placed under vacuum, the vacuum sheet 51 presses, directly or indirectly, on the apexes 121b of the hollow acoustic elements 121 of the acoustic component 120 such that the acoustic component 120 is pressed against the acoustic skin 110. The vacuum is produced through orifices opening into the vacuum chamber 50.

The vacuum sheet 51 must be made of a transparent material in order to enable laser welding of the upper faces 122a of the edges 122 of the acoustic component 120 with the acoustic skin 110 while continuing to hold it in position.

The vacuum chamber 50 can also be delimited by a reference surface 52, with the acoustic skin 110 resting on the reference surface 52. The reference surface 52 comprises a plurality of orifices 52a disposed in the continuation of the perforations 111 in the acoustic skin 110. The air or gases present inside the vacuum chamber 50 can thus be drawn out through the orifices 52a in the reference surface 52 and through the perforations 111 in the acoustic skin 110, in order to create a vacuum in the vacuum chamber 50. By drawing out air or gases through the perforations 111 in the acoustic skin 110, it is easier to create a vacuum inside the hollow acoustic elements 121. Thus, the acoustic skin 110 is more securely held in position relative to the acoustic component 120. However, it does not depart from the scope of the invention if the vacuum is produced by means of other orifices.

The vacuum sheet may comprise one or more rigid portions of transparent material. For example, the vacuum sheet may comprise a plate of transparent material intended to apply pressure to the acoustic component 120, i.e. on the apexes 121b of the hollow acoustic elements 121. This plate can, for example, be made of a rigid transparent polymer, for example polycarbonate (PC) or polyetherimide (PEI). The plate can be designed to be in direct contact with the apexes 121b of the hollow acoustic elements 121. The use of such a plate integrated into the vacuum sheet can limit the risk of damage, or even perforation, of said bag by the apexes 121b of the hollow acoustic elements 121. Such a plate also improves the repeatability of the position-holding step. The plate preferably has a geometry adapted to the acoustic component 120. Thus the plate is not necessarily flat.

A grid 53 can also be positioned between the vacuum sheet 51 and the apexes 121b of the hollow acoustic elements 121, said grid 53 being positioned in contact with the apexes 121b of the hollow acoustic elements 121. If the orifices 53a in the grid 53 are not superimposed on the connecting edges 122 of the acoustic component 120, the grid 53 must also be made of transparent material in order to enable laser welding.

The grid 53 is intended to be in contact with the vacuum sheet 51, as illustrated in FIG. 4. The grid 53 is intended to apply pressure on the acoustic component 120, i.e. on the apexes 121b of the hollow acoustic elements 121, when the chamber 50 is placed under vacuum. The use of such a grid 53 ensures that the pressure is evenly distributed over the apexes 121b of the hollow acoustic elements 121 and improves the repeatability of the position-holding step. Such a grid 53 also limits the risk of damage, or even perforation, of said sheet by the apexes 121b of the hollow acoustic elements 121.

Once the position holding is achieved, laser welding is carried out while continuing the position holding, as shown in FIG. 5. The laser welding is carried out by emitting a laser beam 60 such that said laser beam 60 passes through a connecting edge 122 of the acoustic component 120 made of transparent material without heating, as far as the interface between said connecting edge 122 and the acoustic skin 110 made of opaque material. The laser beam 60 thus passes through the lower face 122b of the connecting edge 122 and then through the upper face 122a of the connecting edge 122. If the acoustic skin 110 and the acoustic component 120 are held in position by a sheet 51, the laser beam 60 passes through said sheet 51, the lower face 122b of the connecting edge 122 and then the upper face 122a of the connecting edge 122. Preferably, the laser beam passes through the lower face 122b and the upper face 122a of the connecting edge 122, perpendicular to said surfaces 122a and 122b.

A laser emitter 61 can be used. The encounter of the laser beam 60 with the acoustic skin 110 made of opaque material causes a concentration of energy at the interface between the connecting edge 122 and the acoustic skin 110, so as to generate localised heating 6. Such localised heating 6 causes the connecting edge 122 to weld to the acoustic skin 110. The resulting weld bead can be between 1 and 3 mm thick. This operation is repeated for each connecting edge 122 to be welded to the acoustic skin 110. After cooling, the acoustic skin 110 and the acoustic component 120 are joined together.

In the present application, infrared welding using an infrared beam is considered to be laser welding using a laser. The laser welding can, of course, be carried out using a laser with a wavelength corresponding to visible light.

The acoustic skin 110 and/or the upper face 122a of the connecting edges 122 of the acoustic component 120 may be treated before the welding operation, for example by plasma treatment, in order to activate the surfaces to be welded.

The acoustic component 120 is assembled with the multicellular body 130 so that the upper edges 131a of the partitions 131 are fixed in contact with the lower faces 122b of the connecting edges 122 of the acoustic component 120. Thus, the second assembly face 120b of the acoustic component 120 is fixed in contact with the first assembly face 130a of the multicellular body 130. The assembly of the acoustic component 120 with the multicellular body 130 can, for example, be carried out by welding or bonding.

If a closure skin 140 is present, the closure skin 140 is assembled with the multicellular body 130, such that the lower edges 131b of the partitions 131 are fixed in contact with the closure skin 140. Thus, the second assembly face 130b of the multicellular body 130 is fixed in contact with the acoustic skin 140. The assembly of the closure skin 140 with the multicellular body 130 can, for example, be carried out by welding or bonding. The closing skin 140 can also be formed directly by automatically depositing fibres on the multicellular body 130, the heating tool of the depositing head enabling the deposited strips to be welded to the lower edges 131b of the partitions 131.

The acoustic panel 100 is thus obtained. The acoustic panel 100 can be used, for example, for acoustic attenuation in an aircraft nacelle or engine, for a blade platform or for an aeronautical sleeve.

The expression “between . . . and . . . ” should be understood as including the limits.

1. A method for manufacturing an acoustic panel comprising the assembly of at least one acoustic component with an acoustic skin, the acoustic component comprising a plurality of hollow acoustic elements having a shape progressively tapering between a base and an apex, the bases of the hollow acoustic elements being connected to one another by connecting edges, the assembly comprising:
positioning the acoustic skin in contact with the connecting edges of said acoustic component,
holding the acoustic skin in position against the connecting edges, and
attaching the connecting edges of the acoustic component to the acoustic skin while continuing to hold it in position,
wherein the connecting edges of the acoustic component are made of a thermoplastic material that is transparent for at least one determined laser wavelength, and in that the acoustic skin is made of a thermoplastic material that is opaque for at least the determined laser wavelength,
wherein attachment of the connecting edges to the acoustic skin comprises emitting a laser beam having the determined wavelength and passing through the connecting edges until it reaches the contact interface between the connecting edges and the acoustic skin so as to cause localised heating at said contact interface resulting in welding of the connecting edges to the acoustic skin, and
wherein the acoustic skin is held in position against the connecting edges of the acoustic component during the attachment, by means of a sheet made of transparent material placed under vacuum, the sheet being configured to apply pressure to the apexes of the hollow acoustic elements of the acoustic component so that the connecting edges of the acoustic component are held against the acoustic skin, the laser beam passing through said sheet before passing through the connecting edges during the attachment.

2. The method according to claim 1, wherein a grid is interposed between the sheet and the acoustic component, said grid being in contact with the apexes of the hollow acoustic elements.

3. The method according to claim 1, wherein the connecting edges of the acoustic component are made of polyetherimide or polyethersulfone resin.

4. The method according to claim 1, wherein a plasma treatment is carried out on the acoustic skin and/or on the connecting edges of the acoustic component before attachment.

5. The method according to claim 1, wherein the acoustic skin has a plurality of perforations before being assembled with the acoustic component.

6. The method according to claim 1, wherein the acoustic skin is made of a composite material comprising long fibres.

7. The method according to claim 1, to the method further comprising assembling at least one multicellular body with one or more acoustic components, the assembly between the multicellular body or bodies and the acoustic component or components being carried out such that the hollow acoustic elements are disposed in the cells of the multicellular body or bodies.
